(19) United States
(12) Patent Application Publication
(10) Pub. No.: US 2023/0160638 A1
(43) Pub. Date: May 25, 2023

(54) UNIFIED PROPULSION SYSTEM AND AUXILIARY RADIATOR

(71) Applicant: Polestar Performance AB, Goteborg (SE)

(72) Inventors: Kaine Evans, Gothenburg (SE); Kevin White, Gothenburg (SE); Steve Rhymes, Gothenburg (SE)

(21) Appl. No.: 17/534,133

(22) Filed: Nov. 23, 2021

(51) Int. Cl. F28D 1/04; B60K 1/02; B60K 1/04; B60K 11/00

(52) U.S. Cl. CPC F28D 1/0435; B60K 1/02; B60K 1/04; B60K 11/00; F28D 2021/0092

(57) ABSTRACT

A compact, lightweight multilayer heat exchanger for an electric vehicle, including a first heat exchanger configured to enable cooling of a first heat conducting fluid medium traversing therethrough, and a second heat exchanger configured to enable cooling of a second heat conducting fluid medium traversing therethrough, wherein at least portions of the first heat exchanger are in contact with the second heat exchanger enabling heat transfer between the first heat exchanger and second heat exchanger.

### TECHNICAL FIELD

The present disclosure relates generally to a vehicle heat exchanger, and more particularly to a unified propulsion system and auxiliary heat exchanger for an electric vehicle.

### BACKGROUND

Electric vehicles are becoming increasingly popular as consumers look to decrease their environmental impact and improve air quality. Instead of a traditional internal combustion engine, electric vehicles include one or more electric motors or drive units, powered by a rechargeable battery pack. As is well known, these electric motors generate heat during use, which must be discharged through an active cooling system, often through circulation of a heat conducting fluid medium through one or more fluid conduits adjacent to the electric motors to absorb at least some of the heat generated by the electric motors, then through a radiator or other type of heat exchanger to transfer the heat to air passing over the radiator through conduction.

Typically electric vehicles additionally include a number of auxiliary systems that also generate heat (e.g., air conditioning units, braking systems, batteries, etc.). Such auxiliary systems dissipate heat through a variety of methods. For example, with air-conditioning units the system may include a heat exchanger or radiator to dissipate the heat generated by the auxiliary system into air passing over the heat exchanger. Because auxiliary systems have different cooling requirements and operate over a different range of temperatures than electric motor heat exchangers, auxiliary and electric motor heat exchangers have remained separate systems, being positioned apart from one another to reduce the likelihood of heat on intentionally being transferred from one heat exchanger to the other.

The inclusion of multiple heat exchangers (e.g., both an electric motor radiator and auxiliary heat exchanger) adds both bulk and weight to the vehicle, which can negatively affect an operating range of the vehicle. The installation of multiple heat exchangers also adds to the amount of labor necessary to construct the vehicle. The present disclosure addresses these concerns.

### SUMMARY OF THE DISCLOSURE

Embodiments of the present disclosure provide a unified propulsion system and auxiliary radiator configured to reduce an overall weight and package space dedicated to heat exchangers within an electric vehicle, as well as reducing the quantity of fixings and mounts to secure the heat exchangers and the amount of labor necessary to construct the vehicle.

One embodiment of the present disclosure provides a compact, lightweight multilayer heat exchanger for an electric vehicle, including a first heat exchanger configured to enable cooling of a first heat conducting fluid medium traversing therethrough, and a second heat exchanger configured to enable cooling of a second heat conducting fluid medium traversing therethrough, wherein at least portions of the first heat exchanger are in contact with the second heat exchanger enabling heat transfer and use of shared components between the first heat exchanger and second heat exchanger.

In one embodiment, the first heat exchanger is configured to provide cooling to an electric vehicle propulsion system. In one embodiment, the second heat exchanger is configured to provide cooling to an auxiliary system for an electric vehicle. In one embodiment, the first heat conducting fluid medium remains isolated from the second heat conducting fluid medium, and wherein shared components and contact between the first heat exchanger and the second heat exchanger enable heat transfer between the first heat conducting fluid medium and the second heat conducting fluid medium and a reduction in the number of components in the heat exchanger. In one embodiment, each of the first heat exchanger and the second heat exchanger include a plurality of cross tubes, the plurality of cross tubes of the first heat exchanger positioned parallel to the plurality of cross tubes of the second heat exchanger.

In one embodiment, the heat exchanger further includes a plurality of heat dissipating fins, each of the heat dissipating fins contacting at least one cross tube of the plurality of cross tubes of the first heat exchanger and at least one cross tube of the plurality of cross tubes of the second heat exchanger. In one embodiment, at least one of the heat dissipating fins contacts at least two cross tubes of the plurality of cross tubes of the first heat exchanger at least two cross tubes of the plurality of cross tubes of the second heat exchanger. In one embodiment, the first heat conducting fluid medium traversing through the first heat exchanger and the second heat conducting fluid medium traversing through the second heat exchanger are configured to operate in a temperature range of between about 70° C. and about 80° C. In one embodiment, the first heat conducting fluid medium traversing through the first heat exchanger and the second heat conducting fluid medium traversing through the second heat exchanger are configured to operate below a temperature of about 75° C.

Another embodiment of the present disclosure provides an electric vehicle having a compact, lightweight multilayer heat exchanger, the electric vehicle including a vehicle body, a propulsion system including a rechargeable battery and one or more electric motors, an air-conditioning system, and a combined heat exchanger, including a first heat exchanger configured to enable cooling of a first heat conducting fluid medium traversing therethrough, and a second heat exchanger configured to enable cooling of a second heat conducting fluid medium traversing therethrough, wherein at least portions of the first heat exchanger are in contact with the second heat exchanger enabling heat transfer and shared use of components between the first heat exchanger and second heat exchanger.

In yet another embodiment, the present disclosure provides a compact, lightweight multilayer heat exchanger for an electric vehicle, including a first heat exchanger configured to enable cooling of a first heat conducting fluid medium traversing therethrough, the first heat exchanger including a plurality of cross tubes configured to provide cooling to an electric vehicle propulsion system, a second heat exchanger configured to enable cooling of a second heat conducting fluid medium traversing therethrough, the second heat exchanger including a plurality of cross tubes configured to provide cooling to an auxiliary system for an electric vehicle, the plurality of cross tubes of the second heat exchanger positioned parallel to the plurality of cross tubes of the first heat exchanger, and a plurality of heat dissipating fins, each of the heat dissipating fins contacting at least one cross tube of the plurality of cross tubes of the first heat exchanger and at least one cross tube of the plurality of cross tubes of the second heat exchanger enabling heat transfer and shared use of components between the first heat exchanger and the second heat exchanger, wherein the first heat conducting fluid medium traversing through the first heat exchanger and the second heat conducting fluid medium traversing through the second heat exchanger are configured to operate in a temperature range of between about 70° C. and about 80° C.

The summary above is not intended to describe each illustrated embodiment or every implementation of the present disclosure. The figures and the detailed description that follow more particularly exemplify these embodiments.

### BRIEF DESCRIPTION OF THE DRAWINGS

The disclosure can be more completely understood in consideration of the following detailed description of various embodiments of the disclosure, in connection with the accompanying drawings, in which:

FIG. 1 is a perspective view depicting an electric vehicle having a combined propulsion system and auxiliary heat exchanger, in accordance with an embodiment of the disclosure.

FIG. 2 is a perspective view depicting a combined propulsion system and auxiliary heat exchanger, in accordance with an embodiment of the disclosure.

FIG. 3 is a partial, perspective view depicting a combined propulsion system and auxiliary heat exchanger 200 in accordance with an embodiment of the disclosure.

FIG. 4 is a schematic view depicting a combined heat exchanger system, in accordance with an embodiment of the disclosure

While embodiments of the disclosure are amenable to various modifications and alternative forms, specifics thereof shown by way of example in the drawings will be described in detail. It should be understood, however, that the intention is not to limit the disclosure to the particular embodiments described. On the contrary, the intention is to cover all modifications, equivalents, and alternatives falling within the spirit and scope of the subject matter as defined by the claims.

### DETAILED DESCRIPTION

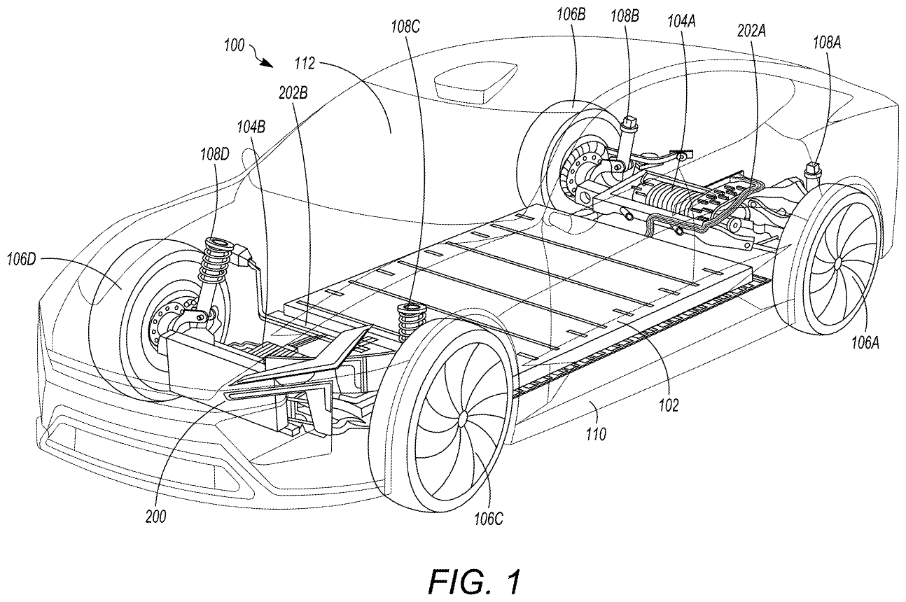

Referring to FIG. 1, an electric vehicle 100 having a combined propulsion system and auxiliary heat exchanger 200 is depicted in accordance with an embodiment of the disclosure. As depicted, a combination of the propulsion system heat exchanger with the auxiliary heat exchanger results in a more compact lighter weight heat exchanger system than the separate heat exchanger systems of the prior art. Moreover, because the propulsion system heat exchanger is integrated with the auxiliary heat exchanger, the overall number of clips, fasteners, fixings and mounts necessary to secure the heat exchangers to the frame of the vehicle is reduced, thereby in turn reducing the amount of labor necessary to construct the electric vehicle.

In embodiments, the electric vehicle 100 can include a rechargeable battery pack 102 electrically coupled to one or more electric motors or drive units 104A-B (collectively referred to herein as a “propulsion system”). The one or more drive units 104A-B can in turn be coupled to a plurality of ground engaging wheels 106A-D. A plurality of spring and damper suspension systems 108A-D can operably couple the ground engaging wheels 106A-D to a body 110 of the vehicle 100.

During operation, the one or more drive units 104A-B can generate heat, which if not dissipated can cause the one or more drive units 104A-B to overheat, potentially resulting in damage to either the drive units 104A-B or other components of the vehicle 100. In order to dissipate the heat generated by the one or more drive units 104A-B, a heat conducting fluid medium can be routed through one or more conduits 202A-B, which in embodiments can at least partially surround or be positioned in close proximity to the drive units 104A-B, thereby enabling the heat generated by the drive units 104A-B to be transferred to the heat conducting fluid medium.

The heat conducting fluid medium, which can be pushed through the one or more conduits 202A-B via a circulation pump or the like, can be routed through the combined propulsion system and auxiliary heat exchanger 200, thereby enabling be heat absorbed by the heat conducting fluid medium from the drive units 104A-B to be dissipated into air passing over the combined heat exchanger 200. Thereafter, circulation of the heat conducting fluid medium can continue to be routed past the drive units 104A-B to dissipate heat generated during operation.

In addition to serving as an anchor point for the drive units 104A-B and engaging wheels 106A-D, the body 110 of the vehicle 100 can define a passenger or cabin area 112, which can be selectively heated or cooled for the comfort of the passengers therein. During cooling operations, refrigerant can be passed through the combined heat exchanger 200 during the high-pressure gas phase of the air-conditioning cycle, thereby enabling heat from the refrigerant to be transferred to air passing over the combined heat exchanger 200.

Because radiators or heat exchangers associated with the propulsion systems often operated at a temperature range of between about 100-120° C., the propulsion system radiator could not be placed in close proximity to and auxiliary (e.g., air-conditioning, etc.) heat exchanger or condenser, which typically operated at a much lower temperature of around 75° C., as heat dissipated from the propulsion system radiator would unintentionally be transferred to the auxiliary heat exchanger, thereby negatively interfering with the traditional high-pressure gas phase of the air-conditioning cycle.

Applicants of the present disclosure have addressed this problem by lowering the normal operating temperature of the heat conducting fluid medium circulated pass the drive units 104A-B to be within a similar temperature range as the heat conducting fluid medium circulated within the auxiliary heat exchanger during the high-pressure gas phase, thereby enabling the propulsion system heat exchanger to be co-positioned with the auxiliary heat exchanger in a multilayer or tiered structure, resulting in a lighter weight, more compact combined heat exchanger 200. For example, in some embodiments, the normal operating temperature of the heat conducting fluid medium passing through the combined heat exchanger 200 can be in a range of between about 70° C. and about 80° C., with a typical steady-state operating temperature of around 75° C.; although the use of other temperature ranges is also contemplated.

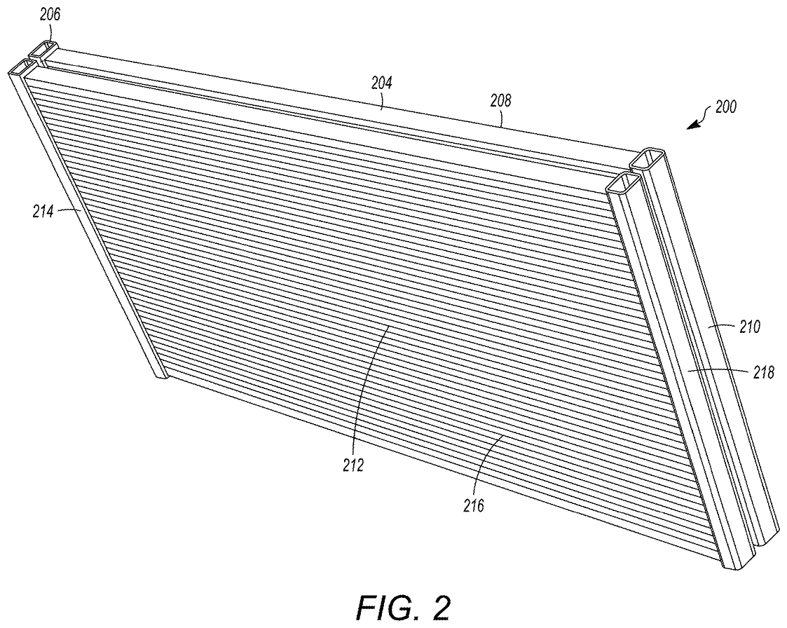

Referring to FIG. 2, a perspective view of a combined propulsion system and auxiliary heat exchanger 200 is depicted in accordance with an embodiment of the disclosure. In embodiments, the combined heat exchanger 200 can include a first heat exchanger 204 enabling a first heat conducting fluid medium to flow into a vertical inlet header 206, which can be in fluid communication with a plurality of cross tubes 208. Thereafter, fluid within the cross tubes 208 can flow into a vertical outlet header 210, thereby completing a flow of the first heat conducting fluid medium through the combined heat exchanger 200.

Similarly, a second heat conducting fluid medium can flow through a second heat exchanger 212, entering into a vertical inlet header 214 which can be in fluid communication with a plurality of cross tubes 216. Thereafter, fluid within the cross tubes 216 can flow into a vertical outlet header 218, thereby completing a flow of the second heat conducting fluid medium through the combined heat exchanger 200. In embodiments, the first heat exchanger 204 can be positioned in close proximity to the second heat exchanger 212, thereby enabling heat to transfer and use of shared components between the heat exchangers 204, 212. That is, in one embodiment, while the first and second heat conducting fluid mediums remain isolated in their own separate systems, shared components and contact between the heat exchangers 204, 212 of the combined heat exchanger 200 can enable a heat transfer between the heat conducting fluid mediums passing through the heat exchangers 204, 212 and a reduction in the number of components used in the construction.

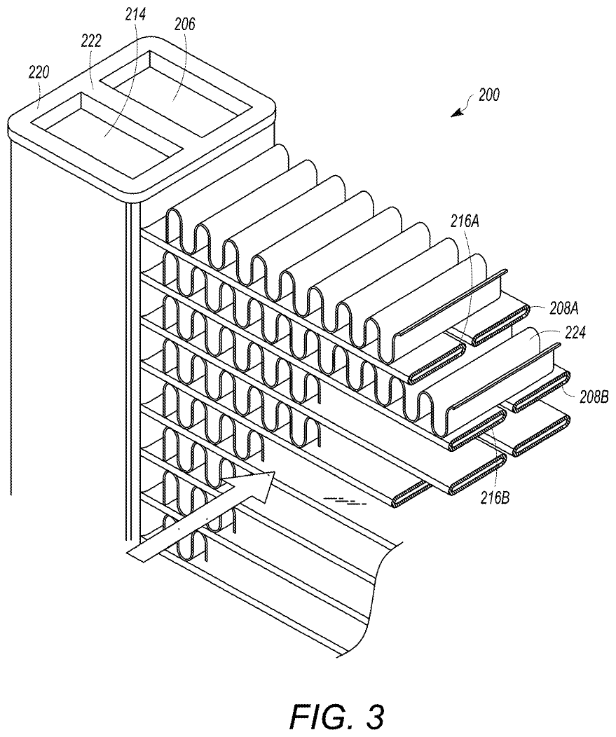

With additional reference to FIG. 3, partial, perspective view of a combined propulsion system and auxiliary heat exchanger 200 is depicted in accordance with an embodiment of the disclosure. As depicted, in some embodiments, the vertical headers 206, 214 and 210, 218 can be constructed of a single unitary member, such that the respective headers share at least one common wall, thereby enabling heat transfer between the heat conducting fluid mediums contained therein and use of shared components. For example, in one embodiment, the combined vertical headers can be extruded from a stock of heat conducting material (e.g., aluminum, etc.). For example, as depicted, in one embodiment, the combined vertical headers can be formed of a substantially rectangular wall 220 defining a pair of substantially rectangular conduits representing vertical headers 206, 214, wherein the wall 220 defines a partition 222 between the substantially rectangular conduits; although the construction of the combined vertical headers through a variety of other techniques and of a variety of other materials is also contemplated.

As further depicted in FIG. 3, in some embodiments, the combined heat exchanger 200 can include heat dissipating fins 224 positioned between the cross tubes 206, 214. For example, in some embodiments, a single heat dissipating fin 224 (e.g., a corrugated heat dissipating fin, or the like) can be positioned between adjacent cross tubes 206, 214, thereby both reducing the overall number of components necessary for the construction of the combined heat exchanger 200, as well as improving a heat transferred between the first and second heat conducting fluid mediums passing through the respective portions of the combined heat exchanger 200.

Accordingly, in some embodiments, a single heat dissipating fin 224 can be configured to contact or otherwise transfer heat from four separate cross tubes, potentially including an upper and lower cross tube 208A-B from a first heat exchanger and an upper and lower cross tube 216A-B from a second heat exchanger; although other configurations of the dissipating fins 224 are also contemplated. Accordingly, the combined heat exchanger is designed to provide a heat transfer between the first heat conducting fluid medium and the second heat conducting fluid medium passing through the combined heat exchanger 200, with portions of the combined heat exchanger 200 at times acting as a heat sink for heat conducting fluid medium of a higher temperature flowing through the heat exchanger 200.

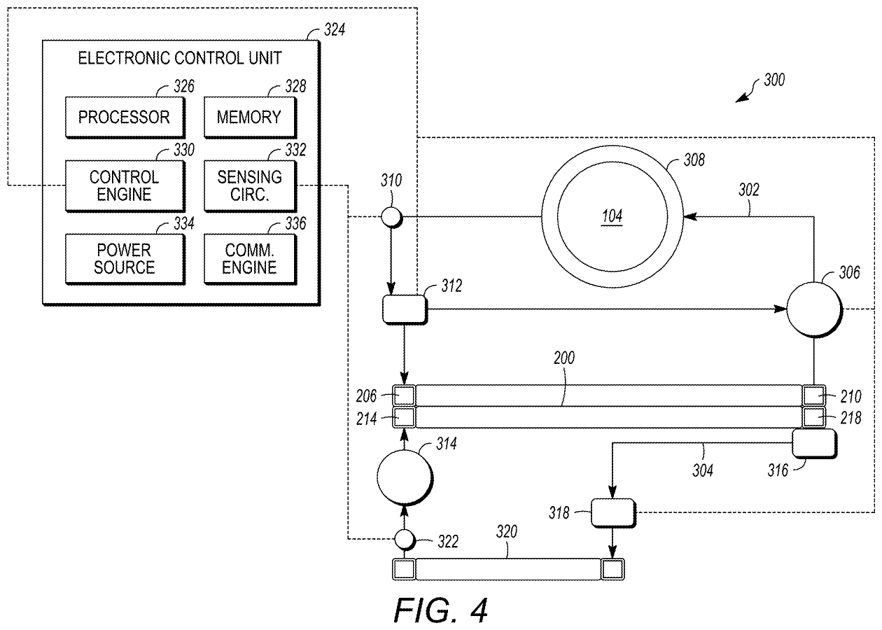

With additional reference to FIG. 4, a schematic view of a combined heat exchanger system 300 is depicted in accordance with an embodiment of the disclosure. In embodiments, the heat exchanger system 300 can include a first heat conducting fluid medium circuit 302 (alternatively referred to as the “propulsion system cooling system”), and a second heat conducting fluid medium circuit 304 (alternatively referred to as the “auxiliary cooling system”), both of which include the combined propulsion system and auxiliary heat exchanger 200.

In the first heat conducting fluid medium circuit 302, a flow of first heat conducting fluid medium can be pulled from the vertical outlet header 218 by a fluid pump 306, which in some embodiments can be selectively driven by an electronic control unit 324. Thereafter, the flow of first heat conducting fluid medium can be routed through a conduit 308 at least partially surrounding the drive unit 104, so as to receive at least some of the heat generated by the drive unit 104. A sensor 310 can be positioned downstream of the conduit 308 to sample data various characteristics (e.g., temperature, flow rate, pressure) of the flow of first heat conducting fluid medium. Based on the sampled characteristics, a valve 312 can route at least a portion of the flow of the first heat conducting fluid medium through the combined heat exchanger 200, with the remaining portion of the flow of the first heat conducting fluid medium returning to the fluid pump 306 (without flowing through the combined heat exchanger 200).

In the second heat conducting fluid medium circuit 304, a flow of second heat conducting fluid medium (which can be in a cool, low-pressure state) can be compressed by a compressor 314 into a flow of hot, high-pressure heat conducting fluid medium. Thereafter, the flow of hot, high-pressure heat conducting fluid medium can enter the vertical inlet header 214 and flow through the combined heat exchanger 200, thereby enabling heat from the second heat conducting fluid medium to be dissipated into air passing over the combined heat exchanger 200. For example, in some embodiments, the combined heat exchanger 200 can serve to condense the flow of second heat conducting fluid medium from a gas to a liquid. The flow of second heat conducting fluid medium exiting the combined heat exchanger 200 can flow through an optional receiver/dryer 316 configured to filter contaminants from the flow of second heat conducting fluid medium. Alternatively, or in addition to the receiver/dryer 316, the second heat conducting fluid medium circuit 304 can include an accumulator, potentially positioned upstream of the compressor 314.

In either case, the flow second heat conducting fluid medium exiting the combined heat exchanger 200 (which is in a cool, but high-pressure state) can flow through an expansion valve 318 causing an expansion and corresponding decrease in pressure and temperature of the flow of second heat conducting fluid medium, resulting in the flow of second heat conducting fluid medium returning to a cool, low-pressure state. Thereafter, the flow of second heat conducting fluid medium can pass through a second heat exchanger 320 which can be configured to absorb heat from a stream of air passing over the heat exchanger 320, thereby effectively cooling the stream of air passing over the heat exchanger 320. A sensor 322 can be positioned downstream of the second heat exchanger 322 sample data various characteristics (e.g., temperature, flow rate, pressure) of the flow of second heat conducting fluid medium.

With continued reference to FIG. 4, in some embodiments, elements of the combined heat exchanger system 300 (e.g., fluid pump 306, valve 312, expansion valve 318, etc.) can be controlled via an electronic control system (ECU) 324. The ECU 324 or components thereof can comprise or include various modules or engines, each of which is constructed, programmed, configured, or otherwise adapted to autonomously carry out a function or set of functions. The term “engine” as used herein is defined as a real-world device, component, or arrangement of components implemented using hardware, such as by an application specific integrated circuit (ASIC) or field programmable gate array (FPGA), for example, or as a combination of hardware and software, such as by a microprocessor system and a set of program instructions that adapt the engine to implement the particular functionality, which (while being executed) transform the microprocessor system into a special-purpose device.

An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

In some embodiments, ECU 324 can include a processor 326, memory 328, a control engine 330, sensing circuitry 332, and a power source 334. Optionally, in embodiments, ECU 324 can further include a communications engine 336. Processor 326 can include fixed function circuitry and/or programmable processing circuitry. Processor 326 can include any one or more of a microprocessor, a controller, a DSP, an ASIC, an FPGA, or equivalent discrete or analog logic circuitry. In some examples, processor 326 can include multiple components, such as any combination of one or more microprocessors, one or more controllers, one or more DSPs, one or more ASICs, or one or more FPGAs, as well as other discrete or integrated logic circuitry. The functions attributed to processor 326 herein may be embodied as software, firmware, hardware or any combination thereof.

Memory 328 can include computer-readable instructions that, when executed by processor 326 cause ECU 324 to perform various functions. Memory 328 can include volatile, non-volatile, magnetic, optical, or electrical media, such as a random access memory (RAM), read-only memory (ROM), non-volatile RAM (NVRAM), electrically-erasable programmable ROM (EEPROM), flash memory, or any other digital media.

Control engine 330 can include instructions to control the components of ECU 324 and instructions to selectively control electrical power to the fluid pump 306, valve 312, expansion valve 318, and other components of the combined heat exchanger system 300. For example, based on conditions detected by sensing circuitry 332 or the vehicle (e.g. other vehicle ECUs), control engine 330 can selectively activate the fluid pump 306, reroute a flow of the first heat conducting fluid medium with a valve 312, adjust an expansion of the second heat conducting fluid medium with the expansion valve 318, or a combination thereof.

In embodiments, sensing circuitry 332 can be configured to sense one or more signals related conditions of the first and second heat conducting fluid medium. Accordingly, sensing circuitry 332 can include or can be operable with one or more sensors 310, 322 (e.g., one or more thermocouples, flow sensors, pressure sensors, etc.). In embodiments, sensing circuitry 332 can additionally include one or more filters and amplifiers for filtering and amplifying signals received from one or more sensors 310, 322.

Power source 334 is configured to deliver operating power to the components of ECU 324. Power source 334 can include a battery and a power generation circuit to produce the operating power (e.g., the battery pack 102, individual battery cells 132, etc.). In some examples, the battery is rechargeable to allow extended operation. Power source 334 can include any one or more of a plurality of different battery types, such as nickel cadmium batteries and lithium ion batteries. Optional communications engine 336 can include any suitable hardware, firmware, software, or any combination thereof for communicating with other components of the vehicle and/or external devices. Under the control of processor 326, communications engine 336 can receive downlink telemetry from, as well as send uplink telemetry to one or more external devices using an internal or external antenna. In addition, communications engine 336 can facilitate communication with a networked computing device and/or a computer network.

Accordingly, embodiments of the present disclosure enable a merger between the electric motor and auxiliary cooling systems, with various components being shared (e.g., a combined heat exchanger 200) between the two systems, thereby significantly reducing the overall size and weight of the combined cooling systems.

The invention is further illustrated by the following embodiments:

A compact, lightweight multilayer heat exchanger for an electric vehicle, comprising: a first heat exchanger configured to enable cooling of a first heat conducting fluid medium traversing therethrough; and a second heat exchanger configured to enable cooling of a second heat conducting fluid medium traversing therethrough, wherein at least portions of the first heat exchanger are in contact with the second heat exchanger enabling heat transfer between the first heat exchanger and second heat exchanger.

A system or method according to any embodiment, wherein the first heat exchanger is configured to provide cooling to an electric vehicle propulsion system.

A system or method according to any embodiment, wherein the electric vehicle propulsion system comprises a rechargeable battery and one or more electric motors.

A system or method according to any embodiment, wherein the second heat exchanger is configured to provide cooling to an auxiliary system for an electric vehicle.

A system or method according to any embodiment, wherein the auxiliary system comprises an air-conditioning system.

A system or method according to any embodiment, wherein the first heat conducting fluid medium remains isolated from the second heat conducting fluid medium, and wherein shared components and contact between the first heat exchanger and the second heat exchanger enable substantial heat transfer between the first heat conducting fluid medium and the second heat conducting fluid medium, and a reduction in the number of components in the heat exchanger.

A system or method according to any embodiment, wherein each of the first heat exchanger and the second heat exchanger include a plurality of cross tubes, the plurality of cross tubes of the first heat exchanger positioned parallel to the plurality of cross tubes of the second heat exchanger.

A system or method according to any embodiment, further comprising a plurality of heat dissipating fins, each of the heat dissipating fins contacting at least one cross tube of the plurality of cross tubes of the first heat exchanger and at least one cross tube of the plurality of cross tubes of the second heat exchanger.

A system or method according to any embodiment, wherein at least one of the heat dissipating fins contacts at least two cross tubes of the plurality of cross tubes of the first heat exchanger at least two cross tubes of the plurality of cross tubes of the second heat exchanger.

A system or method according to any embodiment, wherein the first heat conducting fluid medium traversing through the first heat exchanger and the second heat conducting fluid medium traversing through the second heat exchanger are configured to operate in a temperature range of between about 70° C. and about 80° C.

A system or method according to any embodiment, wherein the first heat conducting fluid medium traversing through the first heat exchanger and the second heat conducting fluid medium traversing through the second heat exchanger are configured to operate below a temperature of about 75° C.

A system or method according to any embodiment, wherein the first heat conducting fluid medium remains isolated from the second heat conducting fluid medium, and wherein shared components and contact between the first heat exchanger and the second heat exchanger enable substantial heat transfer between the first heat conducting fluid medium and the second heat conducting fluid medium.

An electric vehicle comprising heat exchanger according to any embodiment of the disclosure.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A compact, lightweight multilayer heat exchanger for an electric vehicle, comprising:
a first heat exchanger configured to enable cooling of a first heat conducting fluid medium traversing therethrough; and
a second heat exchanger configured to enable cooling of a second heat conducting fluid medium traversing therethrough, wherein at least portions of the first heat exchanger are in contact with the second heat exchanger enabling heat transfer between the first heat exchanger and second heat exchanger.

2. The heat exchanger of claim 1, wherein the first heat exchanger is configured to provide cooling to an electric vehicle propulsion system.

3. The heat exchanger of claim 1, wherein the second heat exchanger is configured to provide cooling to an auxiliary system for an electric vehicle.

4. The heat exchanger of claim 1, wherein the first heat conducting fluid medium remains isolated from the second heat conducting fluid medium, and wherein shared components and contact between the first heat exchanger and the second heat exchanger enable substantial heat transfer between the first heat conducting fluid medium and the second heat conducting fluid medium, and a reduction in the number of components in the heat exchanger.

5. The heat exchanger of claim 1, wherein each of the first heat exchanger and the second heat exchanger include a plurality of cross tubes, the plurality of cross tubes of the first heat exchanger positioned parallel to the plurality of cross tubes of the second heat exchanger.

6. The heat exchanger of claim 5, further comprising a plurality of heat dissipating fins, each of the heat dissipating fins contacting at least one cross tube of the plurality of cross tubes of the first heat exchanger and at least one cross tube of the plurality of cross tubes of the second heat exchanger.

7. The heat exchanger of claim 6, wherein at least one of the heat dissipating fins contacts at least two cross tubes of the plurality of cross tubes of the first heat exchanger at least two cross tubes of the plurality of cross tubes of the second heat exchanger.

8. The heat exchanger of claim 1, wherein the first heat conducting fluid medium traversing through the first heat exchanger and the second heat conducting fluid medium traversing through the second heat exchanger are configured to operate in a temperature range of between about 70° C. and about 80° C.

9. The heat exchanger of claim 1, wherein the first heat conducting fluid medium traversing through the first heat exchanger and the second heat conducting fluid medium traversing through the second heat exchanger are configured to operate below a temperature of about 75° C.

10. An electric vehicle having a compact, lightweight multilayer heat exchanger, the electric vehicle comprising:
a vehicle body;
a propulsion system including a rechargeable battery and one or more electric motors;
an air-conditioning system; and
a combined heat exchanger, including a first heat exchanger configured to enable cooling of a first heat conducting fluid medium traversing therethrough, and a second heat exchanger configured to enable cooling of a second heat conducting fluid medium traversing therethrough, wherein at least portions of the first heat exchanger are in contact with the second heat exchanger enabling heat transfer between the first heat exchanger and second heat exchanger.

11. The electric vehicle of claim 10, wherein the first heat exchanger is configured to provide cooling to an electric vehicle propulsion system.

12. The electric vehicle of claim 10, wherein the second heat exchanger is configured to provide cooling to an auxiliary system for an electric vehicle.

13. The electric vehicle of claim 10, wherein the first heat conducting fluid medium remains isolated from the second heat conducting fluid medium, and wherein shared components and contact between the first heat exchanger and the second heat exchanger enable substantial heat transfer between the first heat conducting fluid medium and the second heat conducting fluid medium.

14. The electric vehicle of claim 10, wherein each of the first heat exchanger and the second heat exchanger include a plurality of cross tubes, the plurality of cross tubes of the first heat exchanger positioned parallel to the plurality of cross tubes of the second heat exchanger.

15. The electric vehicle of claim 14, further comprising a plurality of heat dissipating fins, each of the heat dissipating fins contacting at least one cross tube of the plurality of cross tubes of the first heat exchanger and at least one cross tube of the plurality of cross tubes of the second heat exchanger.

16. The electric vehicle of claim 15, wherein at least one of the heat dissipating fins contacts at least two cross tubes of the plurality of cross tubes of the first heat exchanger at least two cross tubes of the plurality of cross tubes of the second heat exchanger.

17. The electric vehicle of claim 10, wherein the first heat conducting fluid medium traversing through the first heat exchanger and the second heat conducting fluid medium traversing through the second heat exchanger are configured to operate in a temperature range of between about 70° C. and about 80° C.

18. The electric vehicle of claim 10, wherein the first heat conducting fluid medium traversing through the first heat exchanger and the second heat conducting fluid medium traversing through the second heat exchanger are configured to operate below a temperature of about 75° C.

19. A compact, lightweight multilayer heat exchanger for an electric vehicle, comprising:
a first heat exchanger configured to enable cooling of a first heat conducting fluid medium traversing therethrough, the first heat exchanger including a plurality of cross tubes configured to provide cooling to an electric vehicle propulsion system; and
a second heat exchanger configured to enable cooling of a second heat conducting fluid medium traversing therethrough, the second heat exchanger including a plurality of cross tubes configured to provide cooling to an auxiliary system for an electric vehicle, the plurality of cross tubes of the second heat exchanger positioned parallel to the plurality of cross tubes of the first heat exchanger;
a plurality of heat dissipating fins, each of the heat dissipating fins contacting at least one cross tube of the plurality of cross tubes of the first heat exchanger and at least one cross tube of the plurality of cross tubes of the second heat exchanger enabling substantial heat transfer between the first heat conducting fluid medium and the second heat conducting fluid medium, wherein the first heat conducting fluid medium traversing through the first heat exchanger and the second heat conducting fluid medium traversing through the second heat exchanger are configured to operate in a temperature range of between about 70° C. and about 80° C.

20. The heat exchanger of claim 19, wherein at least one of the heat dissipating fins contacts at least two cross tubes of the plurality of cross tubes of the first heat exchanger at least two cross tubes of the plurality of cross tubes of the second heat exchanger.
